(19) United States
(12) Patent Application Publication
(10) Pub. No.: US 2006/0248803 A1
(43) Pub. Date: Nov. 9, 2006

(54) System for removably attaching a center staybar to a window frame

(76) Inventors: Tim Kirk, (US); Steve Brooks, (US); Steven F. Brooker, (US)

Correspondence Address: CESARI AND MCKENNA, LLP, 88 BLACK FALCON AVENUE, BOSTON, MA, 02210, US

(21) Appl. No.: 11/125,347

(22) Filed: May 9, 2005

(51) Int. Cl. E05D 15/16

(52) U.S. Cl. 49/458

(57) ABSTRACT

This invention provides a removable staybar that is securely attached to the window frame and removed easily, with minimal effort after installation of the window, so that the full perimeter of the window frame can be opened and unobstructed for passage of bulky items therethrough. The staybar includes two opposing ends each having a groove and surrounding ramped inner faces. These grooves each pass over a web on a respective attachment member that is fixedly mounted to a side of the window frame. Each web on an attachment member supports a corresponding pair of ramped faces. The ramped faces of each attachment member are oriented so that, when each end of the staybar is moved onto a respective attachment member, the engaging ramped faces cause the ends of the staybar to be forcibly driven toward the adjacent inner-facing sides of the window frame for a tight, abutting fit between the frame faces and respective staybar ends. The staybar is removably secured to the attachment members using a fastener (a screw) on each end that passes through the staybar and into the attachment member. This further drives the mating ramped faces over each other to force each staybar end against the adjacent frame face.

### BACKGROUND OF THE INVENTION

1. Field of the Invention

This invention relates to windows and more particularly to windows having a fixed, center staybar between sashes.

2. Background Information

Modern, high-efficiency windows often employ the use of non-wooden materials such as aluminum and vinyl to construct durable and extremely long-life frames and sashes. Such windows often incorporate multiple panes of glass, filled with inert gas and various ultraviolet, infra red (heat) and visible-light filters. These advanced construction techniques and materials are now commonly applied to sliding windows in which one, or both, of a pair of sashes slide along parallel grooves or tracks in a rectangular frame to allow the window to be opened for ventilation, etc. Such windows can be oriented to is slide vertically, horizontally, or at a non-perpendicular angle (in certain architectural applications).

One very common type of sliding window is known as the “double-hung” design, in which either of a pair of sashes, can be slid freely along a set of tracks in the frame between closed position, in which the sashes mate at a meeting rail and an opened position, in which a gap is created between the sash(es) and the window frame. Since it may be considered unnecessary and/or less-secure to enable both sashes to slide in the frame, an increasingly common form of window provided for new construction and replacement is the so-called “single-hung” window. The single-hung window differs from more-traditional double hung designs in that one of two sashes (typically the top sash in a vertical-sliding arrangement) is fixed (non-sliding) in the frame, while the other sash (typically the lower) is allowed to slide to selectively open and close the window.

FIG. 1 shows a cross-sectional, interior view of a typical single-hung, vertical-sliding window design according to the prior art. This window 100 includes an outer frame 102 that can be constructed from a unitary piece of molded polyvinylchloride (PVC or, simply termed “vinyl”), another durable polymer, or aluminum. The lower sash 104 includes a peripheral, rectangular sash frame 106 that seats against the horizontal bottom side 107 of the window frame 102 when fully closed, as shown. The lower sash 104 rides upwardly and downwardly (double arrow 109) within the frame 102 along tracks or grooves 108 formed within each vertically oriented, inner-facing side 110 (one side being shown) of the frame 102.

The upper sash 112 of this exemplary single-hung window is fixed to the frame 102. The upper sash is, thus, sealed against the frame's horizontally oriented top side 114, and each of the frame's vertical, inner-facing side 110. To provide requisite strength and security to the frame 102 and upper sash 112, a center member or “staybar” 116 is provided in engagement with the bottom edge 117 of the upper sash 112. The staybar 116 acts as a base for the upper sash 112, so that it cannot slide downwardly in the frame 102. The staybar 116 also forms part of a fully surrounding flange 118 that overlaps the upper sash 112, and thereby prevents unintended outward movement or removal of the upper sash 112 from the exterior of the building. Appropriate clips and/or fasteners can be used to further secure the upper sash 112 in place against unintended inward movement and/or removal. Besides providing lateral support to the frame 102, and a sealing, bottom brace from the upper sash, the staybar 116 also provides a sturdy upper member for the meeting rail 120 to seal against and lock to (using locking mechanism 122).

In constructing a window frame, a staybar may be integrally molded with the frame, or provided as a separate piece that is secured using permanent-joining techniques such as welding and/or adhesives. Alternatively, the staybar may be provided as a separate unit that is attached to the frame by fasteners that pass between the frame and staybar. Care must be taken when attaching a staybar to a frame using fasteners that they firmly tie the staybar to the frame.

One technique for fastening a separate staybar (116) to the frame 102 is shown (in phantom) in FIG. 2. This attachment technique entails the passage of screws 202 through the outer faces of the vertical walls 204 of the frame 102, and into the respective ends 210 of the staybar 116. Appropriate bases or dogs 220 are mounted or formed in each end 210 of the staybar for securely receiving the screw end. Tightening the screws 202 the staybar 116 forces the ends of the staybar 116 into close engagement with the inner-facing sides frame 102. This assembly provides a very strong engagement, but, since the screw heads abut the outer-facing sides of the frame 102, these screws become inaccessible once the window is permanently mounted in a cutout in the building wall. This is because the screw heads become effectively buried between the inner drywall and exterior wall covering.

Thus, the staybar of FIG. 2 is not readily removable from the frame after the window is mounted in the wall. However, in many new construction and renovation projects windows are installed early in the project. However, it may be highly desirable in many renovation and new-construction projects to leave a window space as large as possible until after a certain stage of completion, even after windows are installed. This is because many large and bulky items are not easily carried up stairways to an upper level, and are best passed through an upper-story window. For example, large drywall sheets or bathtubs may be delivered to the building after windows are installed. These items are not easily carried up stairways. The presence of a staybar mounted permanently across the span of a window frame effectively prevents passage of such items through an upper-floor window.

While a staybar may be made removable by placing fasteners on the accessible part of window, such approaches may not result in a secure connection that snugly engages the frame and staybar to each other, or that otherwise compromises security. Also, externally-visible screws may be unsightly. A technique for mounting a staybar to a window that provides a snug and secure fit, and allows easy attachment and removal of the staybar to maximize the window opening size is highly desirable. Also, this staybar attachment technique should not compromise the overall aesthetics of the window.

### SUMMARY OF THE INVENTION

This invention overcomes the disadvantages of the prior art by providing a removable staybar that is securely attached to the window frame and removed easily, with minimal effort after installation of the window, so that the full perimeter of the window frame can be opened and unobstructed for passage of bulky items therethrough. The staybar includes two opposing ends each having a groove and surrounding ramped inner faces. These grooves each pass over a web on a respective attachment member that is fixedly mounted to a side of the window frame. Each web on an attachment member supports a corresponding pair of ramped faces. The ramped faces of each attachment member are oriented so that, when each end of the staybar is moved onto a respective attachment member, the engaging ramped faces cause the ends of the staybar to be forcibly driven toward the adjacent inner-facing sides of the window frame for a tight, abutting fit between the frame faces and respective staybar ends. The staybar is removably secured to the attachment members using a fastener (a screw) on each end that passes through the staybar and into the attachment member. The fastener, in one embodiment, is oriented generally in the same direction as the direction of extension (vertical for example) of the frame's inner-facing sides. This further drives the mating ramped faces over each other to force each staybar end against the adjacent frame face.

In one embodiment, each end of the staybar includes an insert that can be constructed from a polymer, or another durable material. The insert carries the groove and ramped inner face. Likewise, each attachment member is a polymer structure that is attached to the inner-facing side of the window frame at an appropriate point, typically along its vertical length at an approximate center point. The attachment member can include a mushroom-shaped structure that passes through a keyhole formed in the inner-facing side. The attachment member is firmly secured to the inner-facing side by a securing screw that is aligned with a receiving hole on the inner-facing side when the mushroom-head is in proper alignment with respect to the keyhole. In one embodiment, the staybar supports the bottom edge of a fixed upper sash and sealingly engages the meeting rail of the lower sash, which is slideable within the frame. The sashes are installed into, and removable from, the frame using conventional mechanisms (i.e. tilting latches, fasteners, clips, etc.). The staybar can be removed quickly at any time by first removing the sashes, then removing the two staybar securing screws and, finally, withdrawing the ends of the staybar from the two respective attachment members.

### BRIEF DESCRIPTION OF THE DRAWINGS

The invention description below refers to the accompanying drawings, of which:

FIG. 1, already described, is a cross-sectional perspective view of the interior side of a single-hung window having a center member or staybar attached to the window frame according to the prior art;

FIG. 2, already described, is a front/exterior-side view of the window of FIG. 1 with the upper and lower sashes removed;

FIG. 3 is a perspective view of a staybar attachment end member according to an illustrative embodiment of this invention;

FIG. 4 is a perspective view of an end of the staybar with the end member inserted thereinto;

FIG. 5 is an exposed fragmentary cross section of the staybar end of FIG. 4 with the attachment member inserted thereinto;

FIG. 6 is a perspective view of a frame-mounted staybar attachment member that mates with the staybar-mounted end member;

FIG. 7 is a side view of the frame-mounted attachment member of FIG. 6;

FIG. 8 is an exploded fragmentary perspective view of the attachment member on one side of the window frame receiving the frame-mounted attachment member of FIG. 6;

FIG. 9 is a fragmentary perspective view of the window frame showing the attachment member of FIG. 6 secured thereon;

FIG. 10 is a fragmentary perspective view of the staybar with the staybar-mounted end member in the process of mounting onto the frame-mounted attachment member;

FIG. 11 is a partially exposed perspective view of the window frame having the staybar secured thereon; and

FIG. 12 is a somewhat schematic perspective view of a room interior with the window frame mounted on a wall, showing the staybar and each of the window sashes removed from the frame to allow a bulky object to be passed through the window.

### DETAILED DESCRIPTION OF AN ILLUSTRATIVE EMBODIMENT

The illustrative embodiment of this invention contemplates a staybar having a pair of end-mounted inserts that allow the staybar to be easily slid into and out of mating inserts located at appropriate positions on opposing sides of the window frame. Accordingly, FIG. 3 shows an end-mounted insert 300 that is adapted to be positioned within the hollow end of a staybar according to an embodiment of this invention. The insert 300 is shaped generally to conform to the complex internal structure of the staybar. It is contemplated that the actual outline of the insert can be any form and that, alternatively, the staybar itself can be formed to include, on its ends, the unitary structure necessary to carry out the function of the insert 300.

In this embodiment, the insert 300 includes a main body section 310 and a frontal extension 312 at the bottom of the main body section. An integrally formed spring clip 314 is provided along the top surface 316 of the main body section. The spring clip, as described below, is designed to firmly secure the insert in place in the end of the staybar. A raised top surface 320 is provided at the top corner of the insert 300. This raised top surface includes a counter-bored hole 322 for receiving a flat head screw to be described further below. The insert can be constructed from a variety of materials including, but not limited to, nylon, Delrin plastic, glass-filled nylon, polystyrene and cast/machined metal (such as aluminum alloy). Extending distally outwardly and forwardly of the wall 330 on the frontal extension 312 is an end cap piece 340. This piece covers a frontal portion of the staybar as described below.

The distal (outermost) end of the insert 300 includes a wall structure 330 having a groove 332 that extends from an opening at the bottom end 334 of the insert upwardly a predetermined distance along the wall 330. In this embodiment the groove 332 has a height GH of approximately ½ inch. The width of the groove is between 0.2 inch and 0.3 inch in one embodiment. Note that all dimensions can be widely varied and are provided mainly to afford the reader appropriate sense of scale. Likewise, while the terms, up, down, forward, rearward, vertical, horizontal, and the like are used to reference the illustrative embodiment, these conventions should be taken only as relative, since the window frame, staybar and sashes can be oriented in any reasonable direction with respect to the direction of gravity.

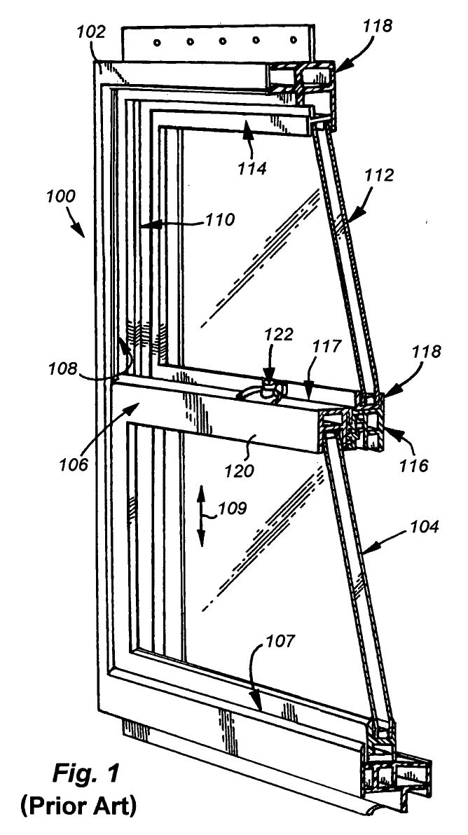

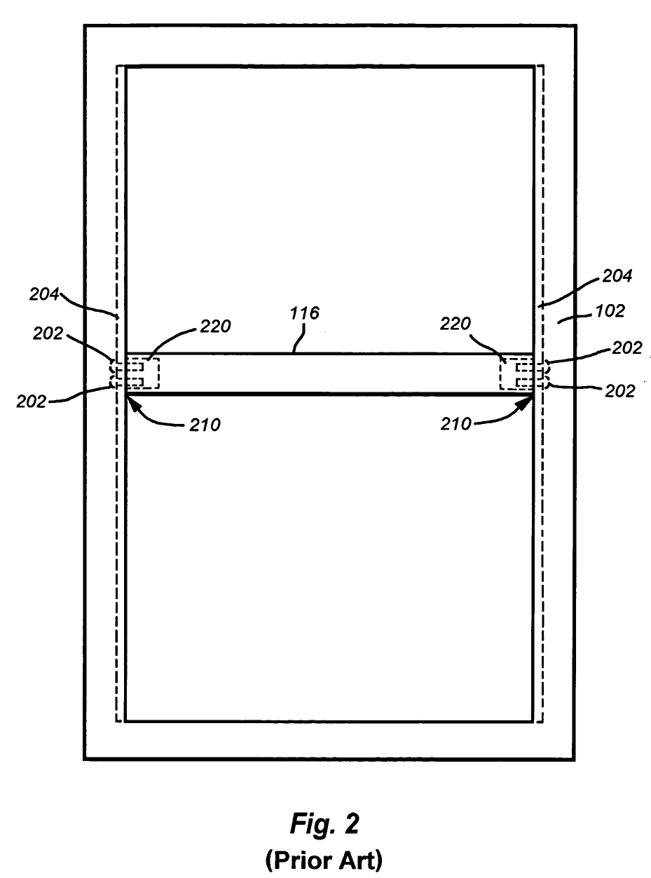

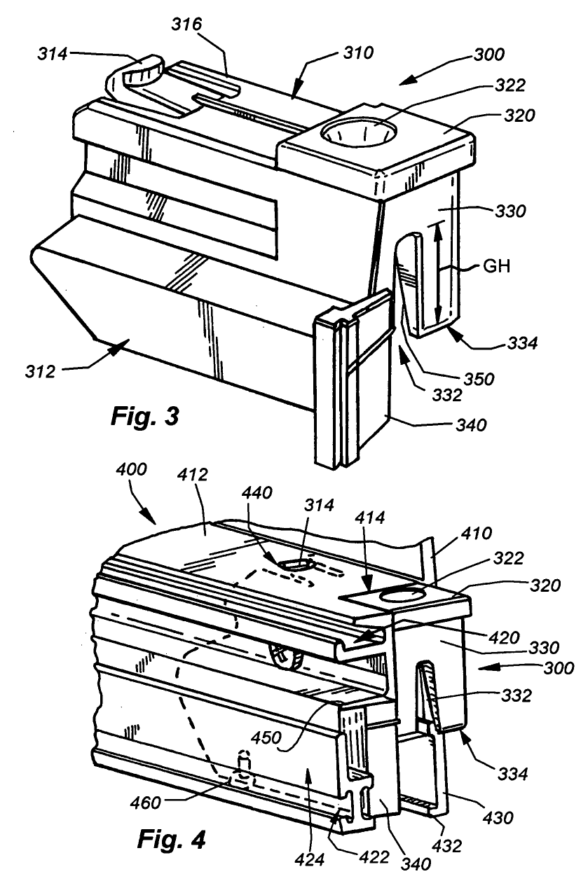

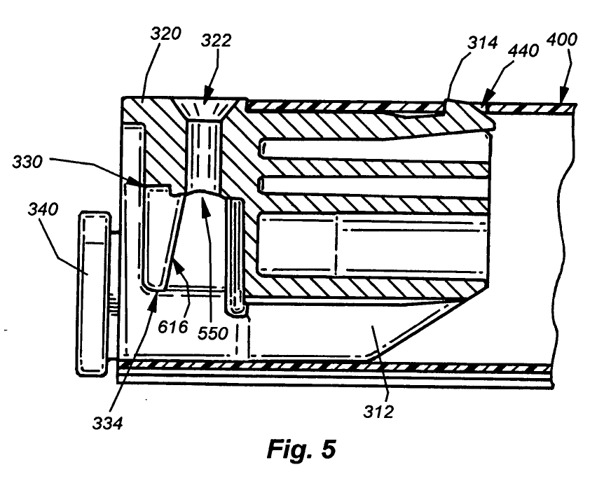

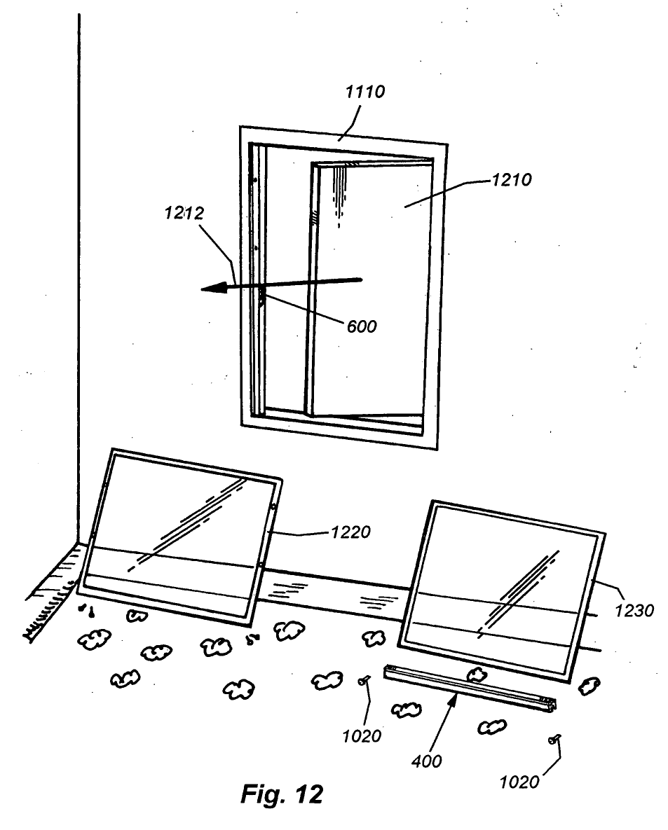

With reference now to FIGS. 4 and 5, the insert 300 is shown (partially in phantom in FIG. 4 and in partial cross section in FIG. 5) secured within an end of a staybar 400 according to an embodiment of this invention. The staybar 400 in this example includes an exterior flange 410 that extends upwardly above a horizontal base section 412. The base 412 and flange 410 serve to capture the lower end of the window's fixed upper sash (refer generally to FIG. 12 below and the exemplary upper sash 112 in FIG. 1). Note that the raised top surface 320 is seated within an L-shaped cut out 414 on the end of staybar's base section 412. The raised top surface 320 thereby forms a flush continuation of the base's top surface.

In this embodiment, the staybar 400 also includes a channel 420 that extends inwardly (toward the interior of the room) from the base section 412. This channel 420 is adapted to receive a glazing bead that is used to lock the lower side of the fixed upper sash (refer to FIG. 12 generally and exemplary upper sash 112 in FIG. 1). A sealing channel 422 and overlying front/inner face 424 are provided along the length of the staybar for mating with the lower sash. This arrangement of seals is highly variable, and is shown only by way of example. The staybar 400 further includes an exterior lower flange 430 that is a downward continuation of the upper flange 410. This flange 430 includes an inwardly turned lip 432 that can provide a drip edge for directing any moisture that contacts the exterior of the window away from the frame. The clip 314 is shown seated within a hole or recess 440 that is formed within the base section 412.

In assembly, when the insert 300 is passed into the hollow end of the staybar, the spring clip 314 is arranged so that it snaps up into the hole/recess 440 when the insert 300 reaches a point of maximum insertion. As such point, the cap 340 engages a corresponding edge 450 along the frontal/interior extension of the staybar 400. To further secure the insert 300 within the end of the staybar 400, a securing screw 460 passes through a hole in the bottom face of the staybar (as shown in phantom), and threads into the material of the insert 300. The screw 460 can be a standard, self-tapping screw that drives into virgin insert material or an appropriate pilot hole in the insert.

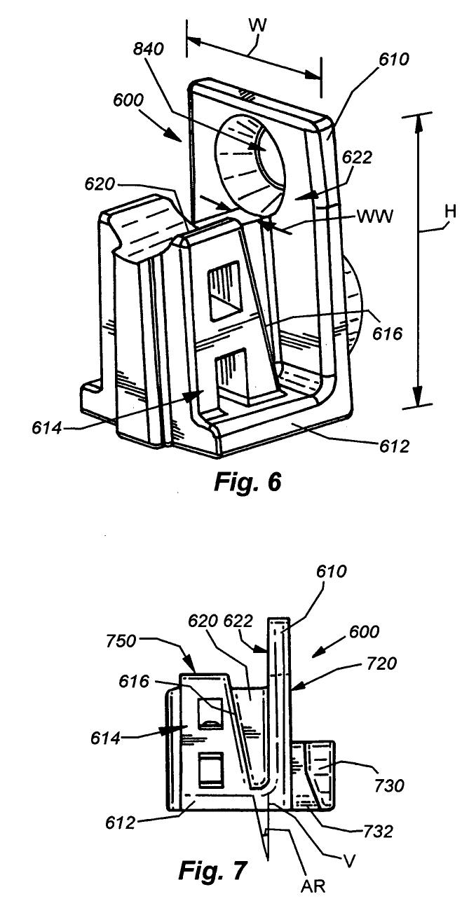

The staybar 400 with assembled inserts 300 attached therein, is, thus, provided with a mounting groove 332 on each opposing end. The groove is sized and arranged to mate with a web (620) that projects from a corresponding window frame-mounted attachment member 600 shown in further detail in FIGS. 6 and 7. In particular, the illustrative attachment member 600 includes a base plate 610 that, as will be described below, is adapted to confront the inner-facing edge of the window frame. An inwardly directed (toward the center of the window), base 612 extends horizontally from the bottom edge of the base plate 610 to define an L-shape therebetween. A mounting block 614 extends upwardly from the horizontal base 612. The web 620 extends from the inner face 622 of the base plate 610, and thereby attaches to the inner surface of the mounting block 614. The web 620 separates the inner surface of the mounting block 614 into a pair of ramped faces 616. The web 620 is sized in width WW to match the approximate width of the groove 332 of the staybar insert 300 (FIG. 3). In one embodiment, the ramped faces 616 are angled at an acute angle AR to the vertical V (taken along the base plate 610) between approximately 5 and 15 degrees (and typically 10 degrees). The ramped faces 616 of the attachment member 600, in particular, conform to the shape, size and angle an associated ramp edge 350 (FIG. 3) on the inner wall of the insert (opposite the outer face 330). Note that the overall height H of the insert is between approximately ¾ and 1 inch and the overall width W of the insert is between approximately ½ and ¾ inch. Of course, these dimensions are widely variable and are provided only for scale.

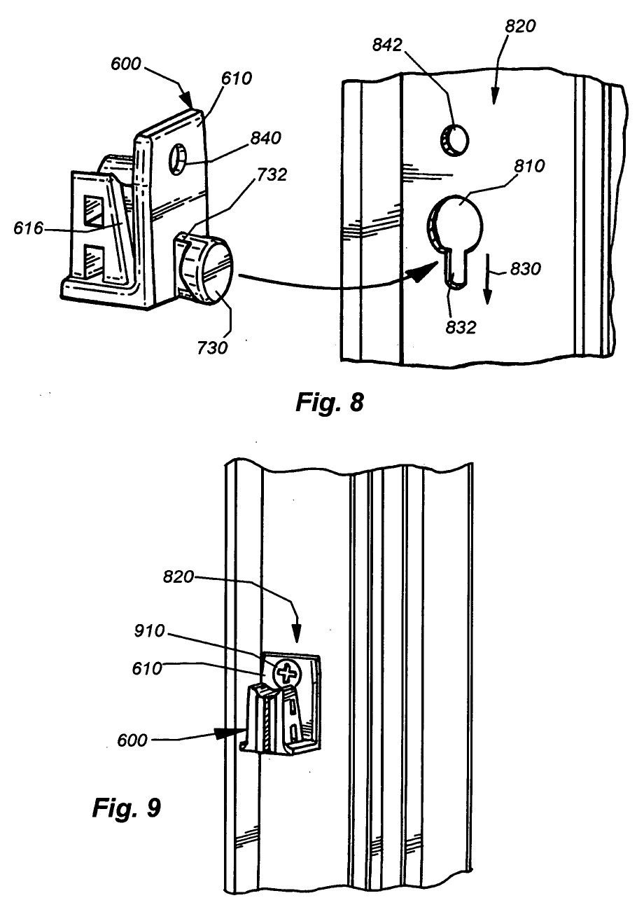

In the illustrative embodiment, the frame-facing face 720 (FIG. 7) of the attachment member 600 includes an enlarged mushroom-shaped head 730 mounted on a rectangular web 732. With reference also to FIG. 8, the mushroom-shaped head 730 is adapted to fit within the enlarged portion of a keyhole 832 formed at an appropriate location around the center (along the vertical direction) of the inner-facing side 820 of the window frame. When the mushroom head is passed through the keyhole 810, the attachment member 600 may then be slid downwardly (arrow 830) so that the mushroom's rectangular web 732 passes into a key slot 832 that extends below the hole. The mushroom head 730 is, thus, captured behind the slot 832. At an appropriate position within the key slot, an upper hole 840 in the attachment member comes into alignment with a corresponding receiving hole 842 on the frame side. In this position, as shown in FIG. 9, a screw 910 is passed through the hole 840 and into the window frame receiving hole 842. This screw 910 thereby secures the attachment member 600 to the inner-facing side 820 of the window frame. Note that the receiving hole 842 in the window frame may be threaded and/or drilled by the screw itself, and need not be provided prior to assembly of the attachment member 600 to the window frame. Alternatively, a rivet, adhesive or other attachment mechanism can be used to secure the attachment member 600 to the frame. Such alternate attachment techniques may or may not employ the mushroom head and keyhole described above.

While one embodiment employs a keyhole and mushroom head to register the attachment member 600 on the frame, it is expressly contemplated that a variety of mechanisms can be employed to align and secure the attachment member to the frame. In an alternated embodiment, the attachment member can include, on its frame-facing face, a push-in snap that engages an appropriate sized and shaped hole (or other formation) on the frame. In general, any device that secures and registers the attachment member relative to a desired position on the face can be employed. Furthermore, where the attachment member is secured to the frame using accurate measurement, jigs, and the like (typically in the manufacturing plant), a securing and registering device can be omitted, and the attachment member can be attached simply using fasteners (screws, rivets, etc.).

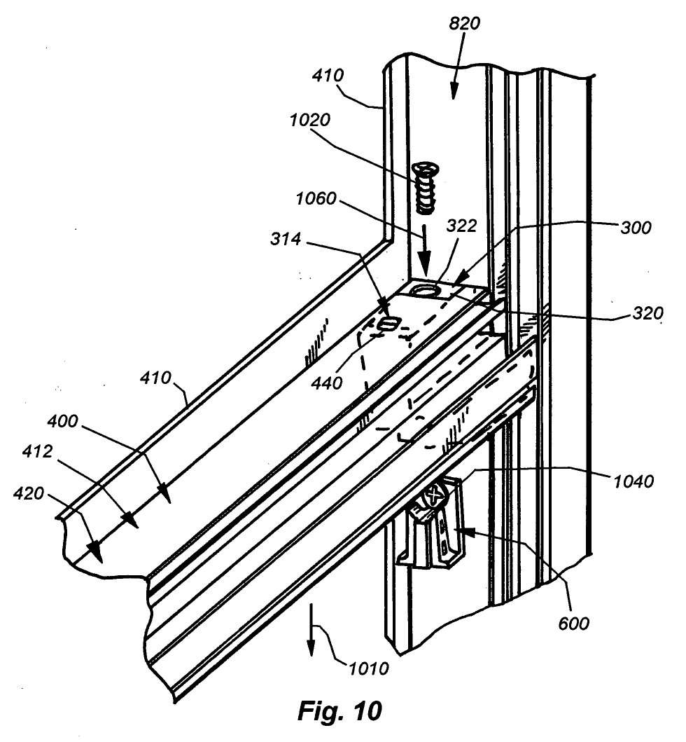

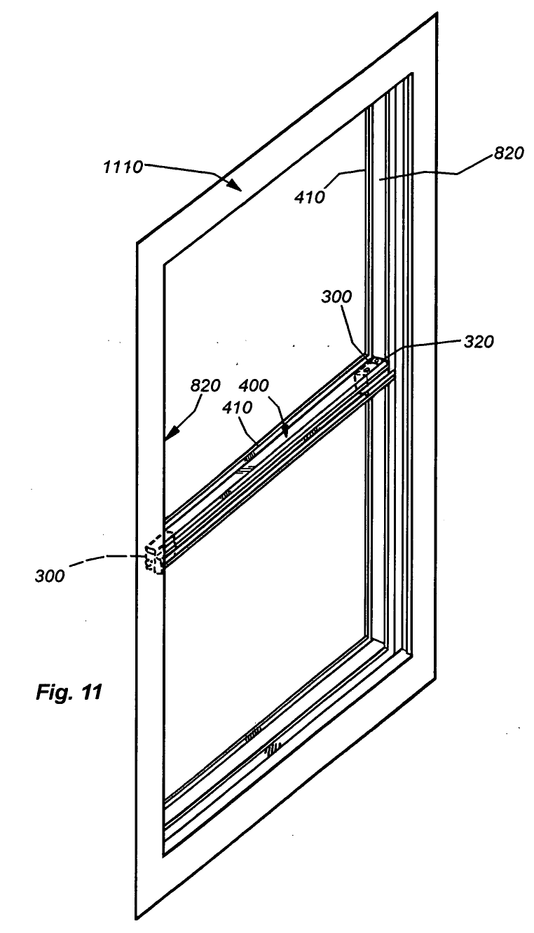

With the attachment member 600 firmly secured to the window frame side 820, the staybar 400 can be lowered into position as shown in FIG. 10. As the staybar 400 is lowered (arrow 1010) the staybar's end groove 332 is passed over the attachment member's web 620. Because the respective, confronting faces of the insert and attachment member 350 and 616 are angled/ramped, as the staybar is passed onto the attachment member, its end is drawn tightly against the inner-facing side 820 of the window frame by a wedging action. Thus, the arrangement of the illustrative embodiment insures that downward movement of the staybar is translated into a firm, laterally (horizontally) acting force to provide a secure and tight fit between the staybar and window frame. To ensure the security of the joint, at least one screw (or another type of fastener) 1020 is passed through the hole 322 in the raised top surface 320 of the insert. This screw taps into the top surface 1040 of the attachment member 600. The screw 1020 can be a self-tapping type of screw that forms its own hole in the attachment member or a pilot hole can be provided in the attachment member. In this embodiment, the screw is directed along an axis (arrow 1060) aligned generally parallel to the (vertical) direction of frame side extension. As such, the screw 1020 exerts a downward force on the staybar with respect to the attachment member causing the angled/ramped faces 350 and 616 of the staybar and attachment member to draw the staybar firmly against the inner-facing side 820 of the window frame 1010. The screw 1020 is turned until it is sufficiently tight at which point the staybar and window frame are firmly secured. Note that the head of the screw 1020 is located so that it is covered by the upper sash when attached, thereby improving the overall aesthetic qualities of the frame.

While a screw 1020 is used to secure the staybar to the attachment member in this example, it is expressly contemplated that any structure (snaps, clips, etc.) that generally prevents unintended detachment of the staybar relative to the attachment member can be employed according to alternate embodiments.

The insert 300 on the staybar 400 is prevented from excessive downward travel with respect to the attachment member 600 by the increasing compression between the two confronting ramped faces 350 and 616. Also, further downward movement of the staybar 400 is positively blocked when the top end 750 (FIG. 7) of the attachment member 600 contacts the interior bottom 550 (FIG. 5) of the insert 300 and/or the base 612 of the attachment member comes into engagement with the bottom end 334 (FIG. 3) of the insert's outer face 330.

The assembled window frame 1110 is illustrated in overall view in FIG. 11. The staybar 400 is secured in place, with its end inserts 300 (shown in phantom) mounted firmly onto the respective attachment members on each inner-facing side 820 of the frame. The window can now receive the fixed upper sash and sliding lower sash as appropriate. Conventional and well known attachment mechanisms (e.g. tilt latches, clips, fasteners, and the like) may be provided to secure the upper sash and the lower sash in place.

Finally, as shown in FIG. 12, whenever a larger window opening perimeter is desired, the window may be quickly disassembled, including removal of the center staybar 400, so that a large item 1210 can be passed (arrow 1212) therethrough. In this example, the upper sash 1220 and the lower sash 1230 are placed conveniently out of the way of the window frame 1110 along with the staybar 400 and its two securing screws 1020. To accomplish full disassembly, once the sashes 1220 and 1230 are removed, the user need only remove the two securing screws 1020 and lift upwardly on the staybar to disengage its ends from the opposing attachment members 600. Reassembly involves the replacement of the staybar ends onto the attachment members 600, reattachment of the two screws 1020 and then attachment of the upper and lower sashes 1220 and 1230.

The foregoing has been a detailed description of an illustrative embodiment of this invention. Various modifications and additions can be made without departing from the spirit and scope thereof. For example, while the attachment member is shown with a web and pair of ramped faces, another structure that keys into the end of the staybar to limit lateral (front-to-rear) motion is also contemplated. Hence the term's “web” and “groove” as used in this context should be taken broadly to define a variety of slotted structures. Also, while the illustrative embodiment shows a window having a pair of vertically oriented sashes with a lower sliding sash, in alternate embodiments, the upper sash may slide or the window may be oriented horizontally (or at an acute angle) relative to the vertical direction of gravity. In addition, a window having more than two sashes, and a corresponding window frame having a plurality of staybars, is contemplated. Additionally, a window in which both sashes are fixed, having a central staybar of the type described generally herein, is also contemplated. Alternatively, a window in which two sliding sashes are provided with a removable staybar according to this invention is also contemplated according to an alternate embodiment. Accordingly, this description is meant to be taken only by way of example and not to otherwise limit the scope of the invention.

What is claimed is:

1. A window frame having a staybar comprising:
A plurality of inner-facing sides disposed about a perimeter of the frame;
an upper sash mounted within the frame;
a lower sash mounted within the frame;
a staybar having a pair of opposing ends, each of the ends having a groove with a ramped inner face; and
an attachment member mounted on opposing inner-facing sides of the frame so as to engage each groove, respectively, each attachment member including a corresponding ramped face constructed and arranged so that, in response to passage of each of the staybar ends over the respective attachment member, the engagement of the ramped face of the staybar and the ramped face of the attachment member causes the respective one of the ends of the staybar to be moved toward and against each adjacent one of the inner-facing sides of the frame member.

2. The window frame as set forth in claim 1 wherein the staybar includes a means for securing the staybar to the attachment member against unintended detachment.

3. The window frame as set forth in claim 2 wherein the means for securing includes a screw that passes through the staybar and into the attachment member to secure the staybar to the attachment member.

4. The window frame as set forth in claim 3 wherein the screw is oriented approximately parallel to a direction of extension of the adjacent one of the inner facing sides of the window frame.

5. The window frame as set forth in claim 4 wherein the staybar includes on each of the opposing ends a respective insert having the groove formed thereon.

6. The window frame as set forth in claim 5 wherein the insert is adapted to be slid into an open end of the staybar and is secured therein.

7. The window frame as set forth in claim 6 wherein the insert is secured to the staybar by a clip that extends into a recess on the staybar.

8. The window frame as set forth in claim 7 wherein the clip comprises a spring-loaded clip formed as an extension of the insert.

9. The window frame as set forth in claim 1 wherein each attachment member includes a structure that registers and secures the attachment member with respect to a pre-determined portion of one of the inner-facing sides.

10. The window frame as set forth in claim 8 wherein the structure comprises a mushroom-shaped head that passes through a keyhole formed on the adjacent one of the inner-facing sides, the attachment member further including a securing screw that engages the attachment member and the adjacent one of the inner-facing sides to secure the attachment member to the adjacent one of the inner-facing sides.

11. The window frame as set forth in claim 1 wherein the frame is constructed and arranged so that the upper sash is fixedly secured to the window frame and the staybar and the lower sash is slideably mounted in the window frame.

12. A method for removably mounting a staybar to a window frame having a pair of opposing inner-facing sides comprising:
moving ends of the staybar into engagement with respective attachment members mounted on each of the inner-facing sides;
passing grooves on the ends having ramped inner faces over opposing ramped faces of the attachment members to draw ends of the staybar into engagement with a respective inner-facing side of the frame; and
securing the staybar to the frame so as to prevent unintended detachment of the staybar from the frame.

13. The method as set forth in claim 12 wherein the step of securing includes attaching fastener that secure the staybar to each of the attachment members.

14. The method as set forth in claim 13 wherein the step of applying includes passing a screw through the staybar and into each of the attachment members.

15. The method as set forth in claim 14 further comprising applying attachment-member-engaging inserts to each of opposing ends of the staybar prior to the step of moving.

16. The method as set forth in claim 10 further comprising mounting the attachment members onto the frame by engaging a structure that secures and registers each of the attachment members to a predetermined position of a respective of the inner-facing sides.

17. The method as set forth in claim 16 wherein the step of engaging includes passing a structure on a frame-facing face of each of the attachment members through a hole on the respective of the inner facing sides.
